(19) United States
(12) Patent Application Publication
(10) Pub. No.: US 2014/0268658 A1
(43) Pub. Date: Sep. 18, 2014

(54) PHOTOMETRICALLY ADJUSTABLE DIFFUSER USING A VARIABLE COMBINATION OF BULK AND SURFACE RELIEF DIFFUSER TECHNOLOGIES, METHODS OF MAKING, AND USE THEREOF

(71) Applicant: ORAFOL Americas Inc., Avon, CT (US)

(72) Inventors: Douglas H. AXTELL, Rochester, NY (US); Arthur DAVIS, Schaghticoke, NY (US)

(73) Assignee: ORAFOL Americas Inc., Avon, CT (US)

(21) Appl. No.: 14/208,542

(22) Filed: Mar. 13, 2014

Related U.S. Application Data
(60) Provisional application No. 61/780,888, filed on Mar. 13, 2013.

(51) Int. Cl. G02B 5/02

(52) U.S. Cl. CPC G02B 5/021; G02B 5/0242; G02B 5/0247
USPC 362/97.2; 362/335; 362/97.1

(57) ABSTRACT

Novel light diffusers that include both bulk and surface diffuser elements are provided. One embodiment includes diffusing elements forming a structured coating on a substantially clear substrate. Another embodiment includes a bulk diffuser with a structured surface. Methods for making and methods of using the light diffusers are also disclosed.

This application claims the benefit of U.S. Provisional Patent Application Ser. No. 61/780,888, filed Mar. 13, 2013, which is hereby incorporated by reference in its entirety.

### FIELD

The present technology is directed to light diffusers that include both bulk and surface diffuser elements. One embodiment includes diffusing elements forming a structured coating on a substantially transparent substrate. Another embodiment includes a bulk diffuser with a structured surface. Methods for making and methods of using the light diffusers are also disclosed.

### BACKGROUND

Diffusers are optical structures that scatter or diffuse light. Most diffusers fall into one of two classes: volumetric type or surface relief type. Volumetric (or bulk) type diffusers consist of an optical media substrate infused with a scattering particulate. The particulate may be reflective (e.g., titanium dioxide) and/or refractive (e.g., beads with an index of refraction differing from the substrate or medium in which they are suspended). Light traversing the volumetric diffuser will be reflected/scattered/refracted many times before exiting. Surface relief type diffusers (or SRDs) have a microstructure at the optical interface which will refract/diffract the incident energy in a “single-pass.” SRDs are characteristically higher efficiency compared with volumetric type diffusers because absorption losses and scattering losses are minimized. However, SRDs often produce an imperfect photometric profile. The present technology is directed to overcoming this and other deficiencies in the art.

### SUMMARY

This technology relates to a light diffuser comprising a transparent substrate and a plurality of lenses forming a complex lens structure on a first surface of the substrate, wherein the plurality of lenses comprise a non-homogenous material.

This technology also relates to a light diffuser comprising non-homogenous substrate wherein a first surface of the non-homogenous substrate forms a complex lens structure.

This technology also relates to a back lighted imaging media comprising a light source and a light diffuser of the present technology.

This technology further relates to a liquid crystal device comprising a light source and a light diffuser of the present technology.

This technology also relates to a method of diffusing light using a light diffuser of the present technology.

In accordance with the present technology, a new class of light diffuser that includes both bulk and surface diffuser elements is provided. One embodiment includes diffusing elements forming a structured coating on a substantially transparent substrate. Another embodiment includes a bulk diffuser with a structured surface. In either form, the volumetric diffuser concentration and refractive index difference between major and minor components in the non-homogenous material can be varied to control the light transmission, source obscuration, and bulk diffusion capabilities.

The light diffusers of the present technology can be used in lighting applications, including solid-state lighting, machine vision applications, automotive applications, transportation signaling applications, and displays, such as rear projection displays, back-lighted imaging media, liquid crystal display components and devices, and in processes for diffusing light.

### BRIEF DESCRIPTION OF THE DRAWINGS

FIG. 1 is a cross-sectional view of one embodiment of a light diffuser of the present technology;

FIG. 2 is a cross-sectional view of a second embodiment of a light diffuser of the present technology;

FIG. 3 is a cross-sectional view of one embodiment of a complex lens of the present technology including semi-spherical microlenses;

FIG. 4 is a cross-sectional view of one embodiment of a complex lens of the present technology including aspherical microlenses;

FIG. 5 is a rectangular plot showing a comparison of a prior art light diffuser and light diffusers of the present technology with differing non-homogenous materials, in particular, four different diffuser formulations and one surface relief design DELTA2-C39 (D2-C39);

FIG. 6 is a polar plot showing a comparison of a prior art light diffuser and light diffusers of the present technology with differing non-homogenous materials, in particular, three different diffuser formulations and two surface relief designs;

FIG. 7 is a rectangular plot showing gain measurements made with four different optical structures created with one resin that is formulated with non-homogenous materials with mixed refractive indices;

FIG. 8 is a polar plot showing gain measurements made with four different optical structures created with one resin that is formulated with non-homogenous materials with mixed refractive indices;

FIG. 9 is a rectangular plot showing a comparison of one surface relief diffuser formed with resins formulated with differing levels of non-homogeneity;

FIG. 10 is a polar plot showing a comparison of one surface relief diffuser formed with resins formulated with differing levels of non-homogeneity;

FIG. 11 is a log scale rectangular plot showing a comparison of two surface relief diffusers, each with homogeneous refractive index material and each with non-homogenous material;

FIG. 12 is a polar plot showing a comparison of a prior art light diffuser and a light diffuser of the present technology;

FIG. 13 is a polar plot showing a comparison of bulk diffuser Makralon Lumen XT (structure as shown in FIG. 2), LMD6u6S (an example of homogenous substrate with a non-homogenous optic structure as shown in FIG. 1), and LE010.7 and LMD11S (examples of homogenous substrate with a homogenous optic structure); and

FIG. 14 is a polar plot showing a comparison of two different formulations of the same optic structure, D2-C39, with the first formulation made with a moderate refractive index acrylate oligomer majority component and a high refractive index minority component and the second formulation made with a high refractive index majority component and a lower refractive index minority component.

### DETAILED DESCRIPTION

Referring to FIG. 1, a light diffuser 100 including a transparent substrate 2 is shown. A plurality of lenses 4 forming a complex lens structure are positioned on a first surface 6 of the substrate 2. The lenses 4 comprise a non-homogenous material. The non-homogenous material includes a majority component 8 and a minority component 10.

Referring to FIG. 2, a light diffuser 200 including a non-homogenous substrate 20 is shown. A first surface 22 of the non-homogenous substrate 20 forms an integrated complex lens structure 24. The substrate 20 and lenses 24 include a majority component 26 and a minority component 28. As used herein, the term integrated means that the substrate 20 and lenses 24 form a continuous unitary structure produced from the same non-homogenous material (i.e., one-piece construction).

As used herein, the term diffuser means a material that is able to transform specular light (light with a primary direction) to a diffuse light (light with random light direction). Light, as referred to herein, means visible light.

As used herein, transparent means a substrate with a total light transmission of about 50% or greater between 400 and 700 nm.

As used herein, a complex lens is a major lens having on a surface thereof a plurality of minor lenses (lenses smaller than the major lens that are formed randomly or in a desired pattern on the major lens, also referred to as microlenses). Thus, a complex lens is a multi-element lens with multiple microlenses at different positions. The number of minor lenses can vary from 2 to about 60, for example.

Suitable materials for the transparent substrate 2 are dimensionally stable, optically clear, and can have a smooth first surface 6. Such materials include, but are not limited to, polyolefins, polyesters, polyarylates, polyethylene terephthalates, polyphenylsulfones, cyclic olefin copolymers, polymethylmethacrylate, polyamides, polycarbonates, cellulosic esters, polystyrene, polyvinyl resins, polysulfonamides, polyethers, polyimides, polyvinylidene fluoride, polyurethanes, polyphenylene sulfides, polytetrafluroethylene, polyacetals, polysulfonates, polyester ionomers, and polyolefin ionomers. Copolymers and/or mixtures of these polymers can also be used. The transparent substrate is preferably not less than 20 microns thick and may be 2 or more millimeters in thickness.

Suitable materials for the majority component include, but are not limited to, monomers and/or oligomers that include epoxy, polyester, urethane, polyether, acrylate, and methacrylate or cationic monomers and oligomers. Various additives including fillers, free-radical initiators, and cationic initiators can be included in the material to improve its performance. See, for example, Sartomer Bulletin 4303 or 4201, the entire teachings of which are incorporated herein by reference. Examples of suitable materials are described, for example, in U.S. Pat. Nos. 5,903,399, 7,252,709, and 7,407,707, the entire teachings of which are incorporated herein by reference.

In one embodiment, the minority component is a scattering particulate, which may be reflective and/or refractive. Suitable examples of minority components include, but are not limited to, titanium dioxide and microbeads, e.g., styrene microspheres, divinyl benzene microspheres, methyl methacrylate microspheres, ethyleneglycol dimethacrylate microspheres, solid glass microspheres, and hollow glass bubbles. The light scattering particulate may also be comprised of these same materials in non-spherical shapes.

In another embodiment, the minority component is air bubbles. Air bubbles will perform similarly to hollow glass bubbles which have an index of refraction close to the index of refraction of the majority component. However, the use of air bubbles as the minority component eliminates the need to add, for example, a separate particulate to the majority component when forming the diffuser of the present technology. Rather, a desired amount and size of air bubbles can be produced, for example, by varying the speed of formation and curing of the majority component.

In a further embodiment, the minority component is luminescent. Suitable luminescent components include, but are not limited to, phosphors and anti-stokes compounds. For a given wavelength range of interest, this has the possibility of yielding greater than 100% efficiency since wavelengths outside the useful spectrum can be up/down converted to wavelengths within the application window. Alternatively, it is possible to strip out unwanted wavelengths with judicious choice of the material excitation energy. Such an embodiment could be used as another component in an LED based lighting fixture for enhancing the color rendering index (CRI).

In one embodiment, the majority component and minority component each have an index of refraction differing by at least about 0.1.

The ratio of the minority and majority components may vary. In one embodiment, the ratio of the minority and majority components is varied so the minority component is greater than about 0.01% of the total mass of the non-homogenous material.

In another embodiment, the non-homogenous material includes between about 0.2% and about 10% of the total weight of the minority component.

In yet another embodiment, the amount of minority component in the non-homogenous material is less than about 30% of the total mass of the non-homogenous material.

In one embodiment, the non-homogenous material has a majority component and minority component having indices of refractions equivalent at one wavelength but with differing dispersion characteristics at all other wavelengths. Depending on the concentration of minority component and aggressiveness of the complex lens (SRD) structure, the diffuser could transition between two completely different design photometrics over the spectrum (going from completely SRD dependent at the matched wavelength to strongly volumetric dependent as the wavelength is shifted).

The complex lenses of the present technology form an optic structure and, in one embodiment, are of a prescribed geometry. In one embodiment, the complex lenses are semi-spherical, meaning that the surface of each complex lens element (minor lens) is a sector of a sphere (but not necessarily a hemisphere). An example of a semi-spherical complex lens in accordance with one embodiment of the present technology is shown in FIG. 3. In another embodiment, the complex lenses are aspherical, where one or more complex lens elements are aspherical. An example of an aspherical complex lens in accordance with one embodiment of the present technology is shown in FIG. 4. Complex lenses that are convex or concave may be used. Combinations of semi-spherical and aspherical elements in the complex lenses may also be used and each minor lens can be uniquely determined.

In one embodiment, each of lenses 4 and 24 is an individual complex lens.

The curvature, depth, size, spacing, materials of construction, and positioning of the complex lenses determines the degree of diffusion, and these parameters are established during manufacture according to the desired use of the diffuser of the present technology. The microstructure dimensions are preferentially scaled so that good structure representation of optical features may be imbued into a photoresist layer using laser lithographic mastering technology. Feature sizes can range in dimension from a minimum of about one micron to an unlimited maximum. An example of an unlimited feature dimension is a linear prismatic structure in which a fixed depth value is written around the circumference of the drum; since the processed drum is then used in a continuous roll-to-roll manufacturing process, the feature length has no boundary.

For applications in which optical elements will be used as part of a visual system, it will often be desirable for the feature size to be small enough as to be imperceptible by the unaided eye. Typically then feature sizes should not subtend more than one arcminute of angle over the distance between the observer and the optic. On the other hand, there are aesthetic benefits to having larger feature sizes, for instance in lighting in which feature elements on the scale of several millimeters or larger can yield a desirable visual aesthetic. Micron scale features can be made into millimeter or larger scaled visual aesthetics by substantially replicating feature slope angles over millimeter scale periodicities.

Overall optical substrate dimensions will be highly application dependent. Typical roll-to-roll processing will yield optical sheets on the scale of one meter wide by unlimited length. With finite element microstructure dimensions on the scale of tens of microns then this corresponds to embodiments yielding hundreds of millions to billions of optical elements per square meter.

In one embodiment, the light diffuser of the present technology is formed from a plurality of integral contiguous layers. The desired number of layers can be determined based on the desired optical design and can include, for example, between 2 and 4 layers. In one embodiment, a light diffuser 100 and a light diffuser 200 can be combined.

In one embodiment, the diffuse light transmission of the light diffusers of the present technology is at least about 50%, or between about 70 and 95%, or greater than about 92%.

In accordance with this technology, optical diffusers can be continuously formed from a radiation curable liquid material using a mold that defines a shape for optical structures to be formed upon the optical film. In particular, this involves placing the radiation curable liquid material in the mold, positioning a radiation transparent base film adjacent to the radiation curable liquid material in the mold, positioning a radiation source such that it can irradiate the curable liquid material while the radiation curable material is in the mold, thereby forming the shape of the optical structures, and curing the liquid material by exposing it to the radiation source.

The light diffusers of the present technology can be used in combination with a light source or display in lighting applications, including solid-state lighting, luminaire lighting, machine vision applications, automotive applications, transportation signaling applications, and displays, such as rear projection displays, back-lighted imaging media, liquid crystal display components and devices, and in processes for diffusing light. Thus, providing a light diffuser of the present technology in combination with a light source or display can produce a diffused light having a desired photometric profile.

The light diffuser is tailored to the light source to be diffused in the above-described applications. In accordance with the present technology, the complex lens (SRD) structure of the light diffuser can be tailored to create a variety of photometric profiles and the bulk diffuser portion including the non-homogenous material can be formulated to augment the desired optical design, or to provide smoothing of the photometrics.

In accordance with the present technology, if the minority component (particulates/air bubbles) is positioned in the substrate to form a non-homogenous substrate, as shown in FIG. 2, the volumetric component of the diffusion profile will be predominantly independent of the surface relief profile. However, if the minority component (particulates/air bubbles) is positioned in the complex lenses forming the surface relief profile and not the substrate, as shown in FIG. 1, the surface relief profile will be a very strong influencing factor on the volumetric diffusion. Notably for microlenses, light which is incident on the shallow slope surfaces (i.e., the central portion of the microlens) traverses a much more diffusive optical path compared to light incident on the high slope angle regions (i.e., the root boundaries of the microlenses). This may be especially useful because the high slope angle components of the microlens determine the cut-off angle of the photometric profile. Consequently, the surface relief profile can be designed for a requisite cut-off angle and then minority component (particulates/air bubbles) can be added to “dial-in” the desired photometric shape within this cut-off cone. This approach should maintain nearly the same high efficiency levels of a pure SRD type diffuser with the added benefit of a smoothed photometric profile and added source/glare obscuration.

### EXAMPLES

### Example 1

### Formation of Light Diffusers with Varied Non-Homogenous Materials

Optical structures were created in a mathematical model and this model was used to create a tool using a proprietary method. The microlens sag profile was tailored for the specific photometric application requirements. In the case of the DELTA2 design for which photometric plots are included herein, the surface sag profile was fit to a simplified asphere equation as shown in Eq. 1:

$$sag ( ρ ) = \frac{c {ρ}^{2}}{2} + {A}_{4} {ρ}^{4} + {A}_{6} {ρ}^{6} + {A}_{8} {ρ}^{8} \qquad ( 1 )$$

where sag(ρ) represents the surface profile with respect to the spatial coordinate (ρ) of the kernel microlens which is tiled up en-masse to cover the film diffuser area. The coefficients for Eq. 1 which may be used for generating the surface sag profile for the DELTA2 design are as follows: c=0.0182, A₄=6.964×10³, A₆=1.197×10⁷ and A_{g}=4.122×10⁹. The tool was filled with energy cure acrylates that were formulated in a separate operation. For the various diffusers formed and tested, the energy cure acrylates included multiple multifunctional acrylate oligomers and monomers in a blend which are in a radiation-curable coating formulation. The blend of materials included a blend of aliphatic urethane acrylate oligomers, propylene diacrylates, dimethanol diacrylates, bisphenol diacrylates, polyester acrylates, polystyrene, alkane diols, silicone diacrylates, benzotriazole, and hindered amine light stabilizers (HALS), with hydroxy-cyclohexyl-phenyl-ketones, trimethylbenzoylphenyl-phosphineoxides, and/or other catalysts that can trigger the cross-linking reaction. A transparent substrate was placed in contact with the tool coated with the energy cure acrylates and this was exposed to an energy source, in particular UV radiation, to form diffusers having a transparent substrate and a plurality of complex lenses on a first surface of the substrate. The light diffusers that were made are set forth in Table 1, below:

TABLE 1
Light Diffusers

| | | | | Majority | Minority |
|---|---|---|---|---|---|
| | Optical | Resin | % | Refractive | Refractive |
| Name | Design | Formulation | Microspheres | Index (n) | Index (n) |
| D2-C39 | D2-C39 | LMD6u6S | 2% | 1.50 | 1.59 |
| LMD6u6S | aka | | | | |
| | DELTA2-C39 | | | | |
| D2-C39 | D2-C39 | DRS3B | 1% | 1.58 | 1.49 |
| DRS3B | | | | | |
| D2-C39 | D2-C39 | LMD11S | 3% | 1.509 | 1.59 |
| LMD11S | | | | | |
| D3-C39 | D3-C39 | LEO10.7u6S | 4% | 1.5 | 1.59 |
| LEO10.7u6S | | | | | |
| D2-C39 | D2-C39 | LEO10.7 | 0% | 1.5 | n/a |
| LEO10.7 | | | | | |
| D3-C39 | D3-C39 | DRS3.5 | 5% | 1.58 | 1.495 |
| DRS3.5 | | | | | |
| D3-C28 | D3-C28 | LEO11.1u8S | 4% | 1.501 | 1.59 |
| LEO11.1u8S | | | | | |
| D2-C39 | D2-C39 | LEO11.1u8S | 4% | 1.501 | 1.59 |
| LEO11.1u8S | | | | | |
| C2-42 | C2-42 | LEO11.1u8S | 4% | 1.501 | 1.59 |
| LEO11.1u8S | | | | | |
| D3-C39 | D3-C39 | LEO11.1u8S | 4% | 1.501 | 1.59 |
| LEO11.1u8S | | | | | |
| D2-C39 | D2-C39 | DRS3.5 | 5% | 1.58 | 1.495 |
| DRS3.5 | | | | | |
| D2-C39 | D2-C39 | DRS3.6 | 6% | 1.58 | 1.495 |
| DRS3.6 | | | | | |
| D2-C39 | D2-C39 | DRS3.75 | 7.5% | 1.58 | 1.495 |
| DRS3.75 | | | | | |
| D2-C39 | D2-C39 | DRS3.X | 10% | 1.58 | 1.495 |
| DRS3.X | | | | | |
| BP303 with | BP303 | CA71 + 603171- | 5% | 1.49 | 1.6 |
| 603171-AY | | AY | | | |
| BP304 with | BP304 | CA71 + 603171- | 5% | 1.49 | 1.6 |
| 603171-AY | | AY | | | |
| BP303 with | BP303 | CA71 | 0% | 1.49 | n/a |
| CA71 | | | | | |
| BP304 with | BP304 | CA71 | 0% | 1.49 | n/a |
| CA71 | | | | | |
| D3-28 | D3-28 | LEO10.7u6S | 4% | 1.50 | 1.59 |
| LEO10.7u6S | | | | | |
| D2-C39 | D2-C39 | LMD6u6S | 2% | 1.502 | 1.59 |
| LMD6u6S | | | | | |
| D2-C39 | D2-C39 | LMD11S | 3% | 1.50 | 1.59 |
| LMD11S | | | | | |
| D2-C39 | D2-C39 | LMD16 | 3% | 1.52 | 1.47 |
| LMD16 | | | | | |

### Example 2

### Comparison of Light Diffusers with Varied Non-Homogenous Materials

A comparison of the various diffuser designs with several different acrylate formulations and a prior art diffuser can be seen in FIGS. 5-14. The prior art diffuser assembly was comprised of first and second downlight diffusers positioned adjacent to a lambertian light transmitting diffuser and to receive a second subset of the first set of light rays to form diffused light exhibiting a distribution pattern of luminous intensity, the first and second downlight diffusers and the lambertian light transmitting diffuser having optical properties cooperating such that the diffused light propagating from the first and second downlight diffusers and the diffused light propagating from the lambertian light transmitting diffuser exit the light control device in a batwing luminous intensity distribution pattern toward the work surface. One variation of this diffuser assembly was comprised of film with surface relief structure. FIGS. 5, 7, and 9 are rectangular plots, FIGS. 6, 8, 10, and 12 are polar plots, and FIG. 11 is a log-scale rectangular plot. As can be seen, the acrylate can be formulated with a variety of majority and minority refractive indices so that the optic can be adjusted in unison with physical parameter changes in the optic structure. In the examples shown in the plots of FIGS. 5 and 9, the optical structure has been held constant (D2-C39), while the refractive index of the resin and the homogeneity of the refractive index have varied. As can be seen from the DRS3.5, DRS3.6, DRS3.75 and DRS3.X examples in FIG. 9, the gain can be decreased while increasing the half-angle yet maintaining the same shape in the polar profile. At lower concentrations the batwing lobes are largely the same, however they decrease as the ratio of nonhomogenous material is increased and the optic approaches the output of a bulk diffuser. As can also be seen herein, changing the ratio of the non-homogenous components or increasing or decreasing the range of the refractive index of the majority and minority components can be used to adjust the gain, change the polar peak output angles, HWHM angle and source obscuration performance of the diffuser.

As can be seen in FIGS. 5 and 9, the shoulders or half angle of the gain can be manipulated as well as controlling the zero order transmission. This is accomplished by controlling the refractive index of the majority component, the refractive index concentration ratio as well as the refractive index delta of the material forming the optic.

FIG. 5 shows diffusers with the same optical structure, D2-C39, made with a homogenous resin, a low index of refraction majority non-homogenous resin with two different sizes of microspheres, and a non-homogenous resin with a majority material having a higher refractive index. The zero angle peaks indicates high transmission of the material without any bulk diffuser present (homogenous resin). As can be seen in FIG. 12, a non-homogenous resin containing microspheres allows the structure to achieve a polar output closer to the ideal diffuser structure.

FIG. 6 shows two diffusers of the same optic structure, D3-C39, with differing refractive index of the majority resin and level of microspheres. As shown in FIG. 6, the polar output can be changed from a moderate delta-wing with LE010.7u6S to a more Gaussian output using DRS3.5. While a homogenous resin, LE010.7 with a similar optical structure, D2-C39 produces a more pronounced polar output.

FIGS. 7 and 8 shows examples of four different optical structures formed using one non-homogenous resin, thus showing the contribution of the optical structure to the polar output.

FIG. 10 contains examples of one optical structure formed using a majority resin of one refractive index and increasing the concentration of the microspheres to change the polar output from a pronounced batwing to a Gaussian output with little impact on the optical efficiency.

FIG. 11 contains examples of two optical structures (BP303 and BP304) produced with homogenous and non-homogenous materials to change the polar output.

FIG. 13 is polar plot showing a comparison of a bulk non-homogenous diffuser Makralon Lumen XT (structure as shown in FIG. 2) with LMD6u6S (an example of homogenous substrate with a non-homogenous optic structure), LEO 10.7, and LMD11S (examples of homogenous substrate with a homogenous optic structure). This figure shows the higher light output angles and greater light output that can be achieved.

FIG. 14 shows two different formulations of the same optic structure, D2-C39, with the first formulation made with a moderate refractive index acrylate oligomer majority material and a lower refractive index minority material (methyl methacrylate and ethylene glycol dimethacrylate microspheres) where the diffusing properties of the blend smooth the output to better match the model diffuser. The second formulation has a high refractive index material of brominated acrylate oligomer in the majority and a lower refractive index material of styrene and divinyl benzene microspheres in the minority material. This second formulation has a larger half-angle and a uniform output closer to the zero axis.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A light diffuser comprising a transparent substrate and a plurality of lenses forming a complex lens structure on a first surface of the substrate, wherein the plurality of lenses comprise a non-homogenous material.

2. The light diffuser according to claim 1, wherein the substrate is selected from the group consisting of polyolefins, polyesters, polyarylates, polyethylene terephthalates, polyphenylsulfones, cyclic olefin copolymers, polymethylmethacrylates, polyamides, polycarbonates, cellulosic esters, polystyrene, polyvinyl resins, polysulfonamides, polyethers, polyimides, polyvinylidene fluoride, polyurethanes, polyphenylene sulfides, polytetrafluroethylene, polyacetals, polysulfonates, polyester ionomers, polyolefin ionomers, and mixtures thereof.

3. The light diffuser according to claim 1, wherein the non-homogenous material includes a majority component and a minority component.

4. The light diffuser according to claim 3, wherein the majority component is selected from the group consisting of an epoxy, polyester, urethane, polyether, acrylate, methacrylate, cationic monomer, and cationic oligomer.

5. The light diffuser according to claim 3, wherein the minority component is a light scattering particulate.

6. The light diffuser according to claim 5, wherein the light scattering particulate is selected from the group consisting of titanium dioxide, styrene microspheres, divinyl benzene microspheres, methyl methacrylate microspheres, ethyleneglycol dimethacrylate microspheres, solid glass microspheres, and hollow glass bubbles.

7. The light diffuser according to claim 3, wherein the minority component is air bubbles.

8. The light diffuser according to claim 3, wherein the minority component is luminescent.

9. The light diffuser according to claim 3, wherein the majority component and minority component each have an index of refraction differing by at least about 0.1.

10. The light diffuser according to claim 3, wherein the non-homogenous material comprises between about 0.2% and about 10% of the minority component.

11. The light diffuser according to claim 1, wherein the non-homogenous material has a majority component and minority component having indices of refractions equivalent at one wavelength but with differing dispersion characteristics at all other wavelengths.

12. The light diffuser according to claim 1, wherein the lenses are semi-spherical.

13. The light diffuser according to claim 1, wherein the lenses are aspherical.

14. The light diffuser according to claim 1, wherein the diffuse light transmission is between about 70 and 95%.

15. A light diffuser comprising non-homogenous substrate, wherein a first surface of the non-homogenous substrate forms a complex lens structure.

16. The light diffuser according to claim 15, wherein the substrate is selected from the group consisting of polyolefins, polyesters, polyarylates, polyethylene terephthalates, polyphenylsulfones, cyclic olefin copolymers, polymethylmethacrylates, polyamides, polycarbonates, cellulosic esters, polystyrene, polyvinyl resins, polysulfonamides, polyethers, polyimides, polyvinylidene fluoride, polyurethanes, polyphenylene sulfides, polytetrafluroethylene, polyacetals, polysulfonates, polyester ionomers, polyolefin ionomers, and mixtures thereof.

17. The light diffuser according to claim 15, wherein the non-homogenous material includes a majority component and a minority component.

18. The light diffuser according to claim 17, wherein the majority component is selected from the group consisting of an epoxy, polyester, urethane, polyether, acrylate, methacrylate, cationic monomer, and cationic oligomer.

19. The light diffuser according to claim 17, wherein the minority component is a light scattering particulate.

20. The light diffuser according to claim 19, wherein the light scattering particulate is selected from the group consisting of titanium dioxide, styrene microspheres, divinyl benzene microspheres, methyl methacrylate microspheres, ethyleneglycol dimethacrylate microspheres, solid glass microspheres, and hollow glass bubbles

21. The light diffuser according to claim 17, wherein the minority component is air bubbles.

22. The light diffuser according to claim 17, wherein the minority component is luminescent.

23. The light diffuser according to claim 17, wherein the majority component and minority component each have an index of refraction differing by at least about 0.1.

24. The light diffuser according to claim 17, wherein the non-homogenous material comprises between about 0.2% and about 10% of the minority component.

25. The light diffuser according to claim 15, wherein the non-homogenous material has a majority component and minority component having indices of refractions equivalent at one wavelength but with differing dispersion characteristics at all other wavelengths.

26. The light diffuser according to claim 15, wherein lenses of the complex lens structure are semi-spherical.

27. The light diffuser according to claim 15, wherein lenses of the complex lens structure are aspherical.

28. The light diffuser according to claim 15, wherein the diffuse light transmission is between about 70 and 95%.

29. A back lighted imaging media comprising a light source and a light diffuser according to claim 1.

30. A back lighted imaging media comprising a light source and a light diffuser according to claim 15.

31. A liquid crystal device comprising a light source and a light diffuser according to claim 1.

32. A liquid crystal device comprising a light source and a light diffuser according to claim 15.
